(19) United States
(12) Patent Application Publication
(10) Pub. No.: US 2015/0106635 A1
(43) Pub. Date: Apr. 16, 2015

(54) SEMICONDUCTOR INTEGRATED CIRCUIT AND METHOD OF CONTROLLING THE SAME

(71) Applicant: FUJITSU LIMITED, Kawasaki-shi (JP)

(72) Inventor: Kentaro KAWAKAMI, Kawasaki (JP)

(21) Appl. No.: 14/579,808

(22) Filed: Dec. 22, 2014

Related U.S. Application Data
(63) Continuation of application No. PCT/JP2012/067210, filed on Jul. 5, 2012.

(51) Int. Cl. G06F 1/08; G06F 1/26; G06F 1/32; G06F 1/12

(52) U.S. Cl. CPC G06F 1/08; G06F 1/12; G06F 1/26; G06F 1/324
USPC 713/300; 713/501; 713/400

(57) ABSTRACT

A semiconductor integrated circuit includes a system bus configured to operate at a first clock, a plurality of arithmetic processing units including a first arithmetic processing unit which is connected to the system bus and operates at a second clock, and a control circuit controlling the system bus and the arithmetic processing units. After checking that an access from the arithmetic processing units to the system bus is not generated, the control circuit changes frequency of the first clock or the second clock.

### CROSS-REFERENCE TO RELATED APPLICATION

This application is a continuation application and is based upon PCT/JP2012/067210, filed on Jul. 5, 2012, the entire contents of which are incorporated herein by reference.

### FIELD

The embodiments discussed herein are related to a semiconductor integrated circuit and a method of controlling the same.

### BACKGROUND

In recent years, reduction in consumption power is strongly demanded for a semiconductor integrated circuit and, as a technique realizing the reduction in consumption power, for example, attention is paid to a technique called DVFS (Dynamic Voltage Frequency Scaling).

Conventionally, a technique is proposed which optimizes power consumed by a CPU by controlling clock frequency and power supply voltage of an arithmetic processing device (CPU) in accordance with a process load required for a system (for example, with reference to Patent Documents 1 and 2).

A technique of optimizing power consumed by a system bus by controlling clock frequency and power supply voltage of the system bus in accordance with the amount of data transferred via the system bus is also conventionally proposed (for example, with reference to Patent Document 3).

Further, a technique of reducing an unstable operation of a CPU at the time of switching a clock frequency while supply of the clock to the CPU is continued is also proposed (for example, with reference to Patent Document 4).

In recent years, as the technique of manufacturing a semiconductor integrated circuit improves, a product in which a plurality of processor core IPs (Intellectual Properties) are integrated in a single LSI chip is also practically used (for example, with reference to Patent Document 5). In such a product, a plurality of CPU cores may be connected to a single system bus (internal bus).

Further, there is also conventionally provided a technique of applying a synchronization circuit using a flip flop (FF), at the time of transmitting/receiving signals to/from two circuits which operate at different clock frequencies, so that the reception-side circuit can receive a signal of an accurate value (for example, with reference to Patent Document 6).

For example, a system is considered to which a synchronization circuit is applied and in which signals are transmitted/received between two circuits, for example, a CPU and a system bus which operate at different clock frequencies. In recent years, an LSI which increases the speed of a process by connecting a plurality of CPU cores (CPUs) to a system bus is also provided.

In the case of applying the DVFS technique to such a plurality of CPUs and a system bus, for example, when the clock frequency of the system bus is changed, a process causing performance deterioration such as control on synchronization circuits in the CPUs or stop of operations of all of the CPUs is performed.

Patent Document 1: Japanese Laid-open Patent Publication No. 2003-324735

Patent Document 2: Japanese Laid-open Patent Publication No. 2005-210525

Patent Document 3: Japanese Laid-open Patent Publication No. 2011-101372

Patent Document 4: Japanese Laid-open Patent Publication No. 2008-092010

Patent Document 5: Japanese Laid-open Patent Publication No. 2006-260568

Patent Document 6: Japanese Laid-open Patent Publication No. 2000-078122

### SUMMARY

According to an aspect of the embodiments, there is provided a semiconductor integrated circuit including a system bus, a plurality of arithmetic processing units, and a control circuit. The system bus is configured to operate at a first clock. The arithmetic processing units include a first arithmetic processing unit which is connected to the system bus and operates at a second clock.

The control circuit is configured to control the system bus and the arithmetic processing units, and wherein after checking that an access from the arithmetic processing units to the system bus is not generated, the control circuit changes frequency of the first clock or the second clock.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a general configuration of an embodiment of a semiconductor integrated circuit.

FIG. 2 is a block diagram illustrating an example of a clock generator in the semiconductor integrated circuit depicted in FIG. 1.

FIG. 3 is a block diagram more specifically illustrating an example of a through circuit in the semiconductor integrated circuit depicted in FIG. 1.

FIG. 4 is a timing chart for explaining data reading operation when the clock frequency of a CPU and that of a system bus are the same in the through circuit illustrated in FIG. 3.

FIG. 5 is a timing chart for explaining data writing operation when the clock frequency of a CPU and that of a system bus are the same in the through circuit illustrated in FIG. 3.

FIG. 6 is a timing chart for explaining data writing operation when the clock frequency of a CPU and that of a system bus are different in the through circuit illustrated in FIG. 3.

FIG. 7 is a flowchart for explaining an example of a process of changing a clock frequency and a power supply voltage.

FIG. 8 is a diagram for explaining an example of an operation of changing the clock frequency of a system bus by a CPU.

FIG. 9 is a diagram for explaining another example of the operation of changing the clock frequency of a system bus by a CPU.

FIG. 10 is a diagram for explaining an example of an operation after the CPU changes the clock frequency of the system bus.

FIG. 11 is a diagram illustrating an example of a state transition machine of a control circuit.

### DESCRIPTION OF EMBODIMENTS

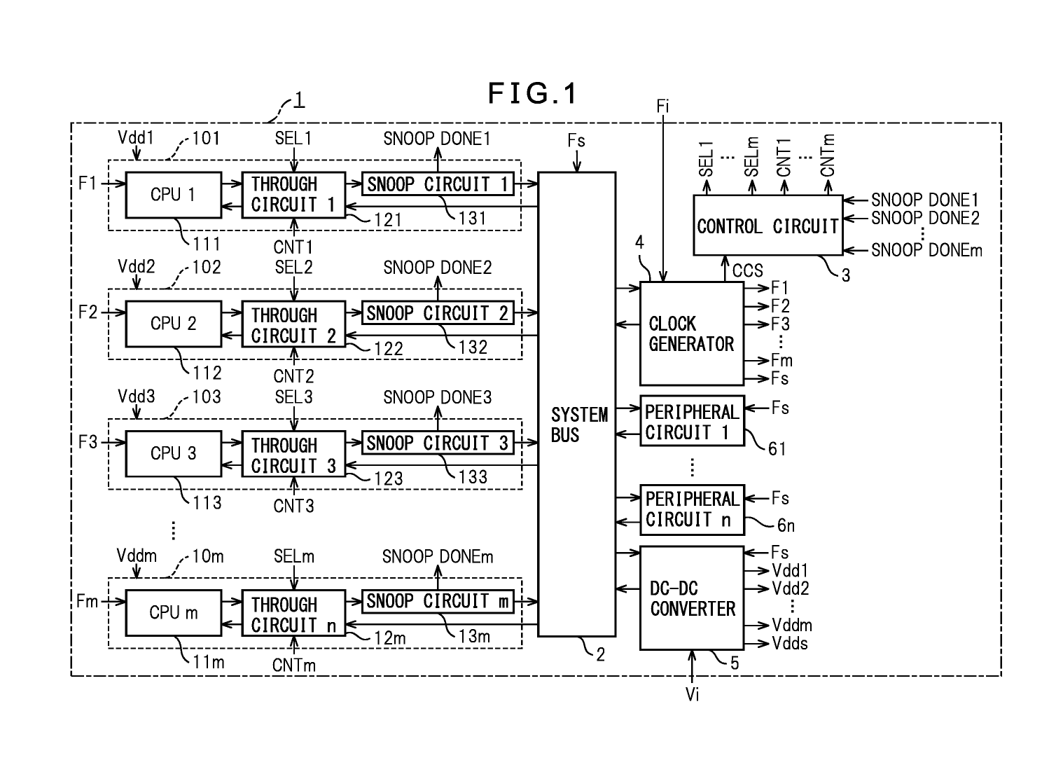

Hereinafter, embodiments of a semiconductor integrated circuit and a method of controlling the same will be described in detail with reference to the appended drawings. FIG. 1 is a block diagram illustrating a general configuration of an embodiment of a semiconductor integrated circuit.

In FIG. 1, reference numeral 1 denotes a semiconductor integrated circuit (LSI), 2 denotes a system bus (internal bus), 3 denotes a control circuit, 4 denotes a clock generator, 5 denotes a DC-DC converter, 61 to 6n denote peripheral circuits, and 101 to 10m indicate computation blocks.

The computation blocks 101 to 10m include CPU cores 111 to 11m (CPU 1 to CPU m), through circuits 121 to 12m, and snoop circuits 131 to 13m, respectively.

As will be described in detail later, the through circuits 121 to 12m select and output either a signal on the transmission side or a signal obtained by synchronizing the clock frequency of the signal on the transmission side with the clock frequency of a signal on the reception side in the CPU cores 111 to 11m and the system bus 2.

The snoop circuits 131 to 13m are circuits, not for making data in local caches match but, as will be described specifically later, for snooping request signals from the corresponding CPU cores 111 to 11m. In other words, the snoop circuits 131 to 13m are, for example, circuits for checking (snooping) that no access request is generated for all of the CPU cores 111 to 11m.

An access request for the CPU cores 111 to 11m is, for example, an access request of a certain CPU core to the system bus 2 or to another CPU core, the clock generator 4, or the peripheral circuits 61 to 6n via the system bus 2.

As illustrated in FIG. 1, in the computation blocks 101 (operation is similarly performed also in 102 to 10m), a signal from the CPU core 111 (processor core IP) to the system bus 2 is supplied via the through circuit 121 and the snoop circuit 131. A signal from the system bus 2 to the CPU core 111 is supplied via the through circuit 121. To the system bus 2, for example, the clock generator 4, n pieces of the peripheral circuits 61 to 6n, and the DC-DC converter 5 are connected.

The clock generator 4 receives a clock Fi as a reference clock signal from the outside of the LSI 1 and generates and outputs clocks F1 to Fm to be supplied to the CPU cores 111 to 11m and a clock Fs. The clock Fs is, for example, supplied to the system bus 2, the peripheral circuits 61 to 6n, and the DC-DC converter 5.

The DC-DC converter 5 receives a power supply voltage V1 supplied from the outside of the LSI 1 and generates and outputs power supply voltages Vdd1 to Vddm to be supplied to the CPU cores 111 to 11m and a power supply voltage Vdds to be supplied to the system bus 2 and the peripheral circuits 61 to 6n. The voltage level of Vdd1 to Vddm and Vdds is controlled, for example, according to a value written in a setting register provided on the inside of the DC-DC converter 5.

To the computation blocks 101 to 10m, dedicated clocks F1 to Fm and the power supply voltages Vdd1 to Vddm are given, respectively. In other words, the clocks F1 to Fm and the power supply voltages Vdd1 to Vddm of the CPU cores 111 to 11m are controlled according to a process load requested for the system (LSI 1) by the DVFS technique.

Concretely, the computation block 101 includes the CPU core 111, the through circuit 121, and the snoop circuit 131. To those circuits, the clock F1 from the clock generator 4 and the power supply voltage Vdd1 from the DC-DC converter 5 are supplied.

The computation block 102 includes the CPU core 112, the through circuit 122, and the snoop circuit 132. To those circuits, the clock F2 from the clock generator 4 and the power supply voltage Vdd2 from the DC-DC converter 5 are supplied.

Further, the computation block 10m includes the CPU core 11m, the through circuit 12m, and the snoop circuit 13m. To those circuits, the clock Fm from the clock generator 4 and the power supply voltage Vddm from the DC-DC converter 5 are supplied.

To the other circuits, in other words, the system bus 2, the control circuit 3, the clock generator 4, and the peripheral circuits 61 to 6n, the power supply voltage Vdds from the DC-DC converter 5 is supplied. To the system bus 2, the control circuit 3, the DC-DC converter 5, and the peripheral circuits 61 to 6n, the clock Fs from the clock generator 4 is supplied.

The control circuit 3 receives a change completion signal CCS from the clock generator 4 and snoop signals 1 to m (“SNOOP DONE1 to SNOOP DONEm”) from the snoop circuits 131 to 13m. The control circuit 3 outputs control signals CNT1 to CN™ and selection signals SEL1 to SELm to the through circuits 121 to 12m, respectively.

In the above, as the system bus 2, for example, AHB (Advanced High performance Bus: registered trademark), APB (Advanced Peripheral Bus), or the like can be applied. Alternatively, the system bus 2 may be, for example, a bus which operates on the basis of a standardized protocol such as AXI (Advanced eXtensible Interface), OCP (Open Core Protocol), or NIF (Native application Interface). Further, a bus which operates on the basis of a protocol uniquely designed by an LSI designer can be also applied as the system bus 2.

As the peripheral circuits 61 to 6n, for example, a system timer, a DMA (Direct Memory Access) controller, an AD (Analog-to-digital) converter, a DA (Digital-to-analog) converter, and the like are used.

As each of the peripheral circuits 61 to 6n, for example, an SPI (Serial Peripheral Interface Bus) interface, a PWM (Pulse width modulation) interface, or the like can be also applied. Further, as each of the peripheral circuits 61 to 6n, for example, a UART (Universal Asynchronous Receiver/Transmitter) interface, a GPIO (General Purpose Input/Output) interface, or the like may be applied.

As described above, the LSI (semiconductor integrated circuit) 1 illustrated in FIG. 1 can independently control the frequencies of the clocks F1 to Fm and the power supply voltages Vdd1 to Vddm in the computation blocks 101 to 10m and the frequency of the clock Fs and the power supply voltage Vdds for the system bus 2 and the peripheral circuits 61 to 6n.

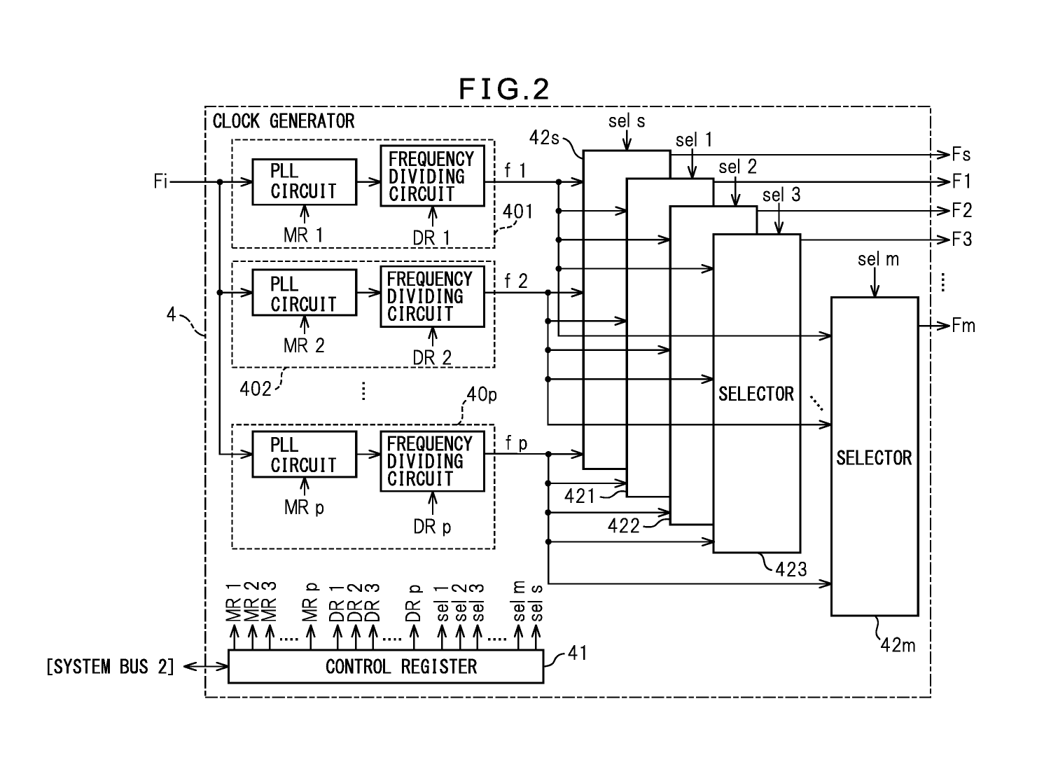

FIG. 2 is a block diagram illustrating an example of the clock generator in the semiconductor integrated circuit depicted in FIG. 1. As illustrated in FIG. 2, the clock generator 4 includes p pieces of clock generation blocks 401 to 40p each having a PLL (Phase Locked Loop) circuit and a frequency dividing circuit, a control register 41, and m+1 pieces of selectors 42s and 421 to 42m.

The PLL circuit performs a feedback control on the basis of the clock Fi supplied and outputs a phase-synchronized signal, and the frequency dividing circuit outputs a signal (clock) obtained by dividing the frequency of the output signal of the PLL circuit to an integral submultiple.

The multiplication factors of the PLL circuits in the clock generation blocks 401 to 40p are controlled by multiplication factor control signals MR1 to MRp from the control register 41, respectively. The frequency division ratios of the frequency dividing circuits in the clock generation blocks 401 to 40p are controlled by frequency division ratio control signals DR1 to DRp from the control register 41, respectively.

The clock generation blocks 401 to 40p output clocks f1 to fp obtained by controlling the input clock signal Fi in accordance with the multiplication factor control signals MR1 to MRp and the frequency division ration control signals DR1 to DRp from the control register 41, respectively. For example, the frequencies (clock frequencies) of the clocks f1 to fp are different from each other.

The clocks f1 to fp are supplied to the selectors 42s and 421 to 42m, clocks according to selection signals sel s and sel 1 to sel m from the control register 41 are selected and output as the clocks Fs and F1 to Fm from the selector 42s and 421 to 42m.

The control register 41 is connected to the system bus 2 and holds, for example, control signals (MR1 to MRp, DR1 to DRp, sel s, and sel 1 to sel m) in accordance with the CPU 1 (CPU core 111) which will be described later.

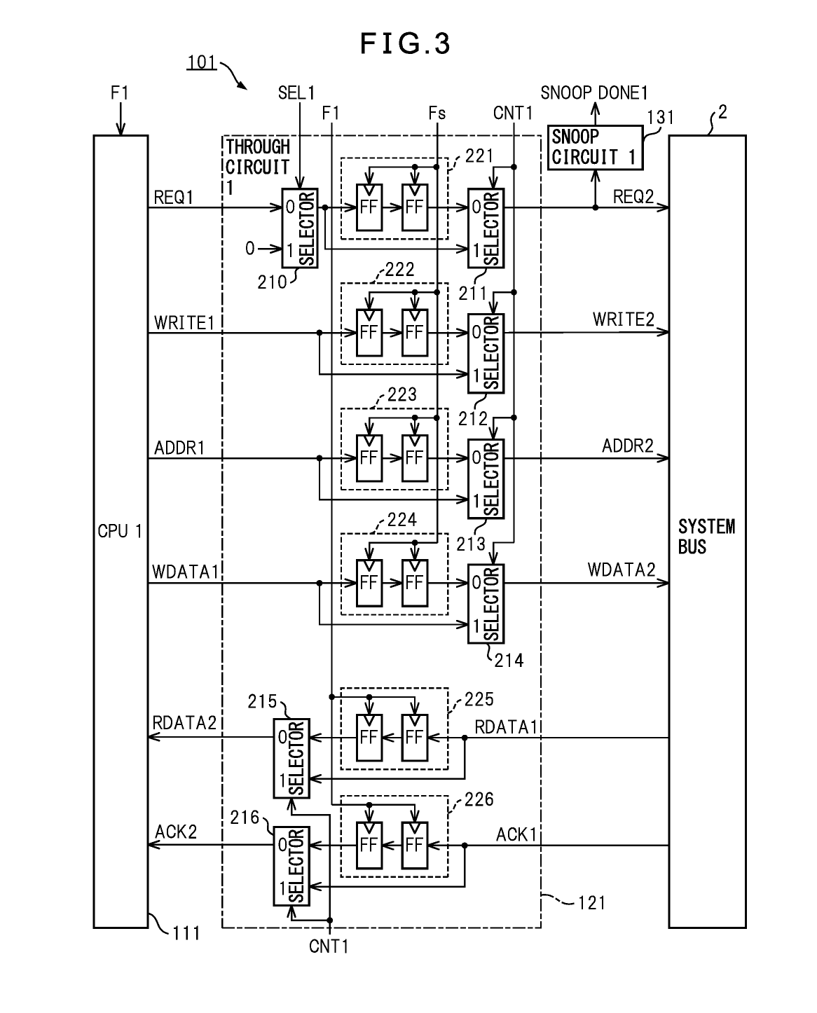

FIG. 3 is a block diagram more specifically illustrating an example of the through circuit in the semiconductor integrated circuit depicted in FIG. 1. Although only one computation block 101 and the system bus 2 are illustrated in FIG. 3, the other computation blocks 102 to 10m are similar.

Between the CPU core 111 (CPU 1) and the system bus 2, a signal REQ indicative of an access request, a signal WRITE discriminating between a write access and a read access, and a signal ADDR indicating an access destination address are transmitted/received.

Further, between the CPU core 111 and the system bus 2, a signal WDATA indicative of a write value at the time of a write access, a signal RDATA indicative of a read value at the time of a read access, and a signal ACK indicating that an access is achieved are transmitted/received.

Signals output from the transmission source are written as REQ1, WRITE1, ADDR1, WDATA1, RDATA1 and ACK1. Signals supplied to a reception destination via synchronization circuits 221 to 226 and selectors 211 to 216 are written as REQ2, WRITE2, ADDR2, WDATA2, RDATA2 and ACK2.

As will be specifically described later, the synchronization circuits 221 to 226 are circuits for making the clock frequency of a signal on the transmission side synchronized with the clock frequency of a signal on the reception side in the CPU core 111 and the system bus 2.

As illustrated in FIG. 3, the selector (access selector) 210, the synchronization circuit 221 and the selector 211 are provided between REQ1 and REQ2, and the synchronization circuit 222 and the selector 212 are provided between WRITE1 and WRITE2.

The synchronization circuit 223 and the selector 213 are provided between ADDR1 and ADDR2, and the synchronization circuit 224 and the selector 214 are provided between WDATA1 and WDATA2.

Each of the synchronization circuits 221 to 224 has flip flops (FF) in two stages whose data fetch is controlled by the same clock Fs as that for the system bus 2, makes the signal from the CPU core 111 synchronized with the system bus 2, and outputs the resultant signal.

The synchronization circuit 225 and the selector 215 are provided between RDATA1 and RDATA2, and the synchronization circuit 226 and the selector 216 are provided between ACK1 and ACK2.

Each of the synchronization circuits 225 and 226 has FF in two stages whose data fetch is controlled by the same clock F1 as that for the CPU core 111, makes the signal from the system bus 2 synchronized with the CPU core 111, and outputs the resultant signal.

The selector 210 is controlled by the selection signal SEL1 from the control circuit 3. When SEL1 is “0: low level L”, the selector 210 selects REQ1 from the CPU core 111 and outputs it. When SEL1 is “1: high level H”, the selector 210 always outputs “0”.

At the time of changing the frequency of the clock Fs (clock frequency Fs) of the system bus 2, it is preferable to continue supply of the clock to a CPU core which does not transmit/receive signals to/from the system bus 2 to continue execution of a program on the CPU core. In other words, by making a CPU core which does not transmit/receive signals to/from the system bus 2 continue execution of a program on the CPU core, deterioration in the performance of the system can be reduced.

When the clock frequency of a CPU core and the clock frequency Fs of the system bus 2 are different, transmission/reception of signals is performed via the synchronization circuits (221 to 226). On the other hand, when the clock frequencies of the CPU core and the system bus 2 are the same, it is preferable to transmit/receive signals without synchronization circuits, thereby avoiding delay in the synchronization circuits.

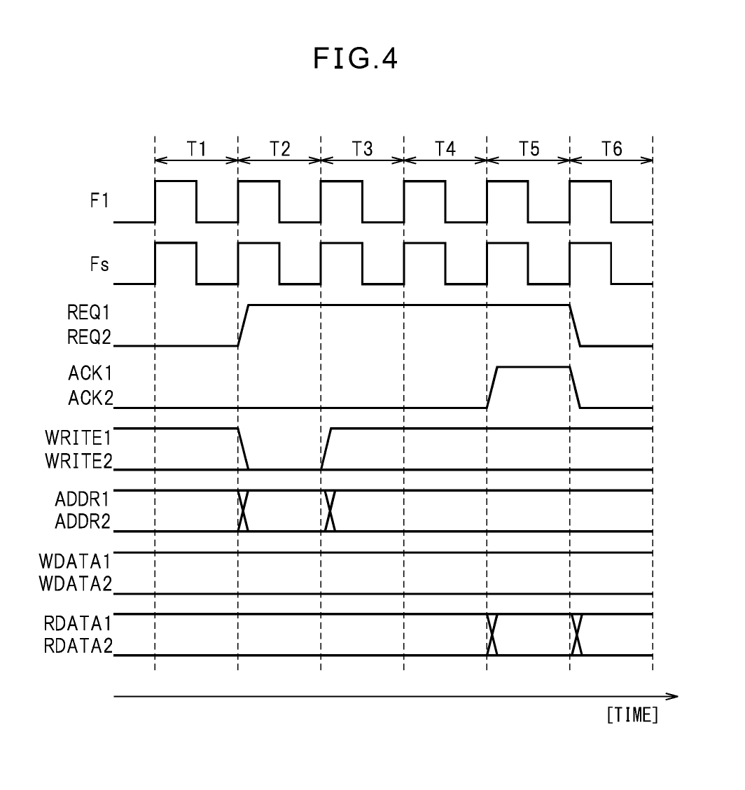

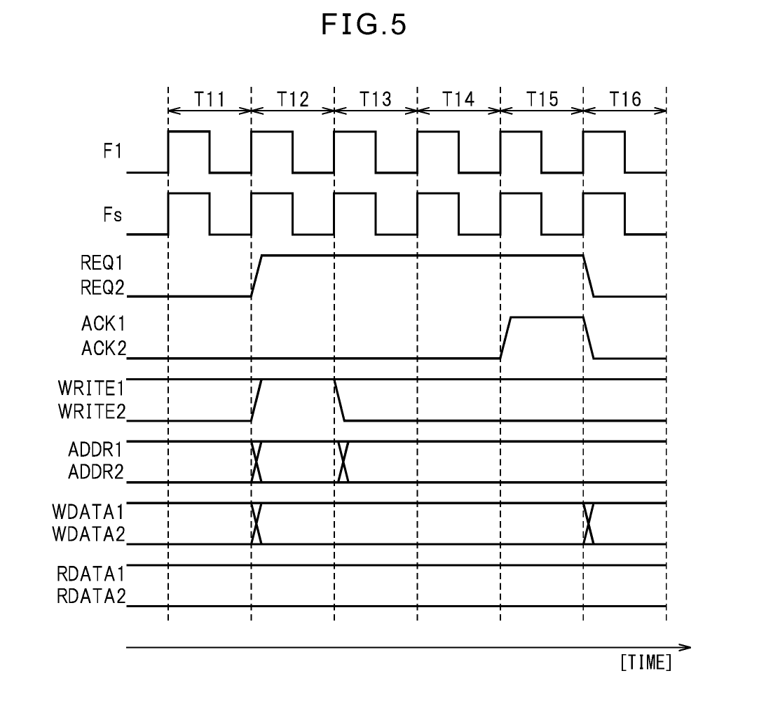

FIGS. 4 and 5 are timing charts for explaining data reading operation and data writing operation when the clock frequency of a CPU and that of the system bus are the same in the through circuit illustrated in FIG. 3.

First, with reference to FIGS. 4 and 5, the operation of an access when the frequency of the clock F1 (clock frequency F1) of the CPU core 111 (CPU 1) and the frequency of the clock Fs for the system bus 2 in the computation block 101 are the same will be described.

When the clock frequency F1 of the CPU core 111 and the clock frequency Fs of the system bus 2 are the same, the value of the control signal CNT1 (CNT1 to CNTm) output from the control circuit 3 is held at “1”, and the selectors 211 to 214 select the input “1” and output it. In other words, the signals REQ1, WRITE1, ADDR1, and WDATA1 are output as they are as REQ2, WRITE2, ADDR2, and WDATA2 without passing through the synchronization circuits 221 to 224.

Similarly, both the selectors 215 and 216 select the input “1” and output it. In other words, the signals RDATA1 and ACK1 are output as they are as RDATA2 and ACK2 without passing through the synchronization circuits 225 and 226.

Therefore, the signals REQ2, WRITE2, ADDR2, WDATA2, RDATA2, and ACK2 have the same values as those of the signals REQ1, WRITE1, ADDR1, WDATA1, RDATA1, and ACK1.

As a result, the output signals from the CPU core 111 are supplied to the system bus 2 without delay, and the output signals from the system bus 2 are supplied to the CPU Core 111 without delay. In other words, when the clock frequencies of the CPU core and the system bus are the same, by transmitting/receiving signals without passing through the synchronization circuits, delay due to the synchronization circuits is avoided.

A master circuit instructing a change in the clock frequency of a CPU core or a system bus is a CPUi (i=1 to m: CPU cores 111 to 11m), and slave circuits are the control circuit 3, the clock generator 4, the DC-DC converter 5, and the peripheral circuits 61 to 6n.

Therefore, for example, when the CPU core 111 (CPU 1) as a master circuit intends to access a slave circuit, a notification is sent by changing REQ1 from “0” to “1”. Similarly, the CPU core 111 transmits the address of the access destination by ADDR1, transmits a signal indicating a write access or a read access by WRITE1, and transmits a value to be written in the case of a write access by WRITE1.

The system bus 2 determines a slave circuit as an access destination on the basis of the address of ADDR1 and accesses the slave circuit as the access destination. When the access is accepted, the acceptance of the access is transmitted by ACK1 and, further, the read value in the case of the read access is transmitted by RDATA1.

Concretely, in the example of the data reading operation in the case illustrated in FIG. 4 where the clock frequency of the CPU core 111 and that of the system bus 2 are the same, a read access occurs in a period T2. In other words, in the period T2, REQ2 changes from “0” to “1” and, simultaneously, the access destination address is transmitted by ADDR1, and a signal indicative of a read access is transmitted by WRITE1.

Further, in a period T5, ACK1 changes from “0” to “1”, thereby transmitting a signal indicating the read access is achieved, and a read value is transmitted by RDATA1. The CPU core 111 receives the read value and the access is completed, so that the CPU core 111 changes REQ1 from “1” to “0” and finishes the access.

In the example of the data writing operation in the case illustrated in FIG. 5 where the clock frequency of the CPU core 111 and that of the system bus 2 are the same, a write access occurs in a period T12. In other words, in the period T12, REQ1 changes from “0” to “1” and, simultaneously, the access destination address is transmitted by ADDR1, and a signal indicative of a write access is transmitted by WRITE1.

Further, in a period T15, ACK1 changes from “0” to “1”, thereby transmitting a signal indicating the write access is achieved, and a write value is transmitted by WDAATA1. The CPU core 111 receives the read value and the access is completed, so that the CPU core 111 changes REQ1 from “1” to “0” and finishes the access in a period T16.

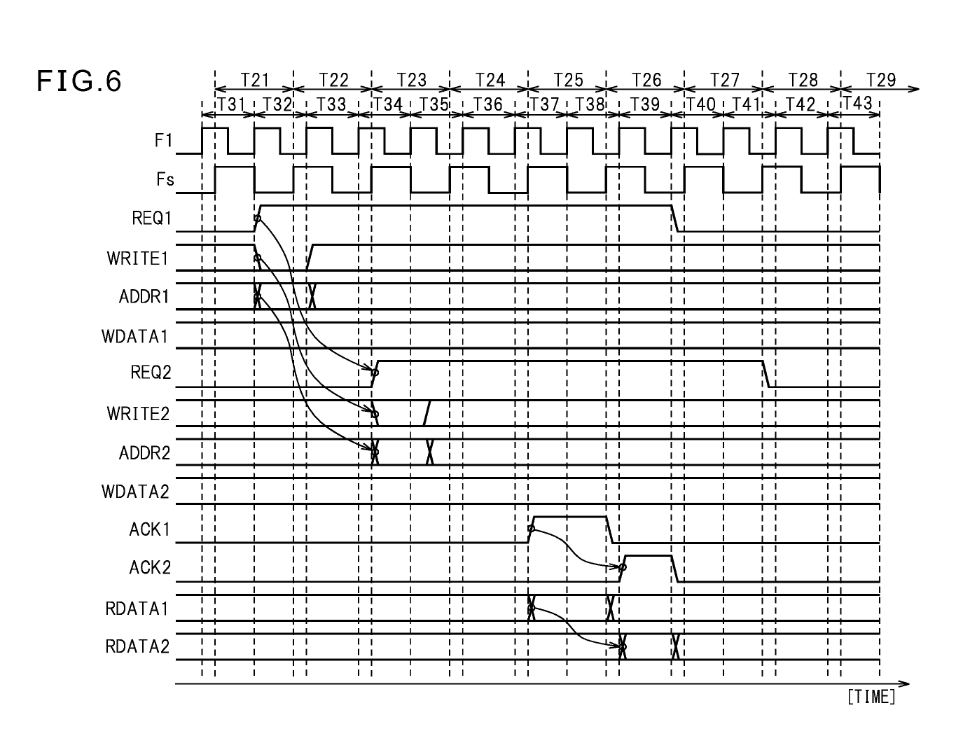

FIG. 6 is a timing chart for explaining data writing operation when the clock frequency of a CPU and that of a system bus are different in the through circuit illustrated in FIG. 3. In other words, in FIG. 6, the frequency of the clock F1 of the CPU core 111 (CPU 1) in the computation block 101 and the frequency of the clock Fs of the system bus are different from each other.

In FIG. 6, reference numerals T21 to T29 indicate periods of timings synchronized with the clock F1 of the CPU core 111, and reference numerals T31 to T43 indicate periods of timings synchronized with the clock Fs of the system bus.

When the clock frequency Fl of the CPU core 111 and the clock frequency Fs of the system bus 2 are different, the control signal CNT1 (CNT1 to CNTm) output from the control circuit 3 is held at “0”, and the selectors 212 to 216 select the input “0” and output it.

In other words, the signals REQ2, WRITE2, ADDR2, WDATA2, RDATA2, and ACK2 become values of the signals REQ1, WRITE1, ADDR1, WDATA1, RDATA1, and AKC1 after passing through the synchronization circuits 221 to 226.

Each of the synchronization circuits 221 to 224 has FFs in two stages in which the data fetch timing is controlled by the same clock Fs as that for the system bus 2, makes a signal from the CPU core 111 synchronized with the system bus 2, and outputs the resultant signal.

Each of the synchronization circuits 225 and 226 has FFs in two stages in which the data fetch timing is controlled by the same clock F1 as that for the CPU core 111, makes a signal from the system bus 2 synchronized with the CPU core 111, and outputs the resultant signal. In other words, each of the synchronization circuits 221 to 226 has FFs in two stages in which the value (synchronization timing) of a clock signal of a circuit on the reception side changes.

Concretely, in the example of the data reading operation in the case illustrated in FIG. 6 where the clock frequency of the CPU core 111 and that of the system bus 2 are different from each other, when REQ1 changes from “0” to “1” in the period T32, REQ2 changes from “0” to “1” in a period T23. In other words, since the synchronization circuit 221 having FFs in two stages in which the signal transition is conducted by the clock Fs of the system 2 is interposed, REQ2 changes from “0” to “1” in the period T23.

Similarly, WRITE1 and ADDR1 (WDATA1) which change in the period T32 also change in the period T23 via the synchronization circuits 222 and 223 (224). When ACK1 changes from “0” to “1” in a period T25, ACK3 changes from “0” to “1” in a period T39 via the synchronization circuit 226. Similarly, RDATA1 which changes in the period T25 changes in a period T39 via the synchronization circuit 225.

As described above, by transmitting/receiving signals via the synchronization circuits 221 to 224, the values of REG2, WRITE2, and ADDR2 (WDATA2) received by the system bus 2 change synchronously with the clock Fs of the system bus 2. Further, by transmitting/receiving signals via the synchronization circuits 225 and 226, the values of ACK2 and RDATA2 received by the CPU core 111 change synchronously with the clock signal Fl of the CPU core 111.

As described above, when the clock frequency of the CPU core 111 and that of the system bus 2 are different, by making the synchronization circuits 221 to 226 interposed, the signals can be transmitted/received properly.

As described above, in a period in which the clock signals of an arbitrary CPUi and the system bus are not switched, the control signal CNTi continues holding “1” or “0”, thereby enabling signals to be properly transmitted/received by the above-described operation. When the clock frequency of CPUi and that of the system bus are the same, as described with reference to FIGS. 4 and 5, by not making a synchronization circuit interposed, signals can be transmitted/received by a route in which no delay occurs.

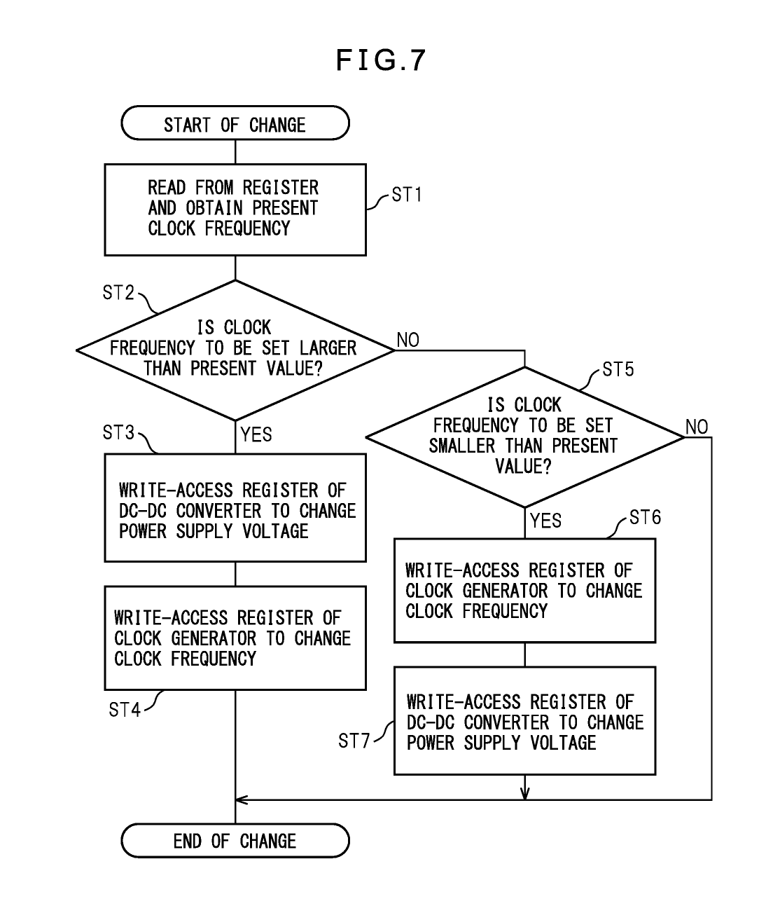

FIG. 7 is a flowchart for explaining an example of a process of changing a clock frequency and a power supply voltage. In the processes illustrated in FIG. 7, both of a change in the clock frequency and the power supply voltage of the CPU (CPU cores 111 to 11m) and a change in the clock frequency and the power supply voltage of the system bus 2 are similar to each other.

As illustrated in FIG. 7, when the process of changing the clock frequency and the power supply voltage is started, in step ST1, a register is read, a present clock frequency is obtained, and the program advances to step ST2.

In step ST2, whether a clock frequency to be set is larger than the present value or not is determined. When it is determined that the clock frequency to be set is larger than the present value, the program advances to step ST3.

In step ST3, a write access is made to a register of the DC-DC converter 5 to change the power supply voltage. Further, the program advances to step ST4 where the register (control register 41) of the clock generator 4 is write-accessed to change the clock frequency and complete (finish) the process. In other words, when the clock frequency to be set is larger than the present value, first, the power supply voltage is changed and, after that, the clock frequency is changed.

On the other hand, in step ST2, when it is determined that the clock frequency to be set is not larger than the present value, the program advances to step ST5. In step ST5, whether the clock frequency to be set is smaller than the present value or not is determined. When it is determined that the clock frequency to be set is smaller than the present value, the program advances to step ST6.

In step ST6, the register of the clock generator 4 is write-accessed to change the clock frequency. Further, the program advances to step ST7 in which the register of the DC-DC converter 5 is write-accessed, the power supply voltage is changed, and the process is completed. In other words, when the clock frequency to be set is smaller than the present value, first, the clock frequency is changed and, after that, the power supply voltage is changed.

In step ST5, when it is determined that the clock frequency to be set is smaller than the present value, in other words, the clock frequency to be set is the same as the present clock frequency, the process is completed.

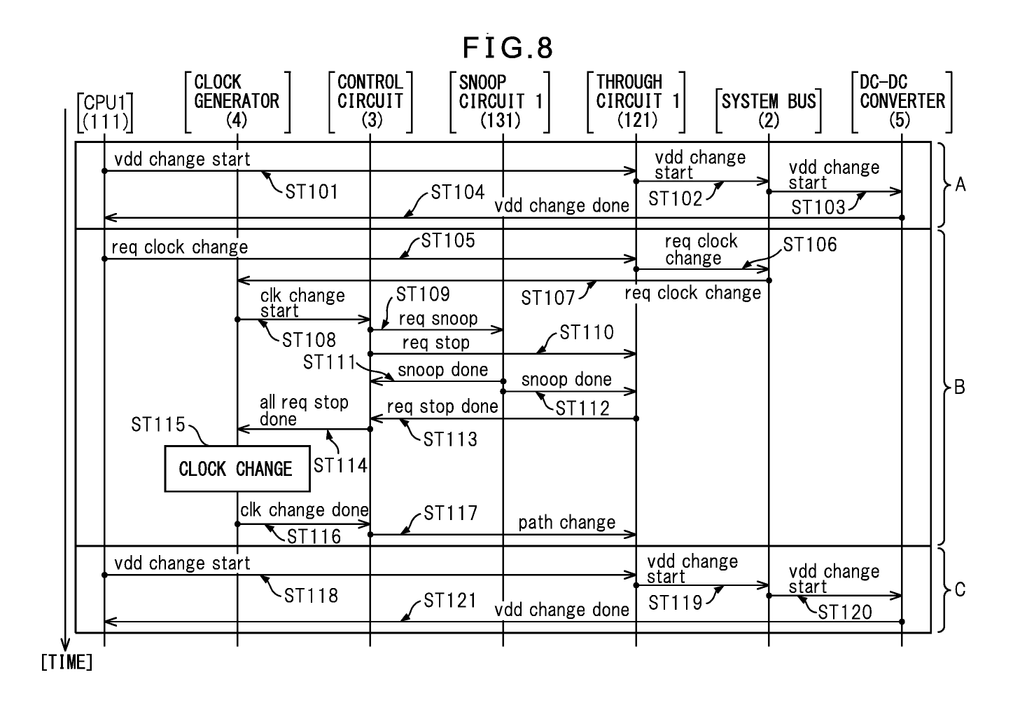

FIG. 8 is a diagram for explaining an example of an operation of changing the clock frequency of a system bus by a CPU. In FIG. 8, the operation A corresponds to, for example, the process in step ST3 in FIG. 7, and the operation B corresponds to, for example, the process in step ST4 in FIG. 7.

In other words, the operation B in FIG. 8 is an operation of performing a process of changing the frequency Fs of the clock of the system bus 2. The operation A in FIG. 8 is an operation of performing a process of increasing the power supply voltage Vdds of the system bus 2 and the peripheral circuits 61 to 6n. The operation C in FIG. 8 is an operation of performing a process of increasing the power supply voltage Vdds of the system bus 2 and the peripheral circuits 61 to 6n.

To make the semiconductor integrated circuit (LSI) 1 operate at a higher clock frequency, in the case of increasing the clock frequency by the DVFS to operate it by higher power supply voltage, first, a high power supply voltage is changed and, after that, the clock frequency is increased. On the contrary, in the case of decreasing the clock frequency by the DVFS, a low clock frequency is changed first, and the power supply voltage is decreased.

Therefore, in the case of increasing the clock frequency by the operation B in FIG. 8, first, the process of increasing the power supply voltage by the operation A and, after that, the process of increasing the clock frequency by the operation B is performed. At this time, the operation C is not executed.

On the contrary, in the case of decreasing the clock frequency by the operation B, without executing the operation A, a process of decreasing the clock frequency is performed by the operation B and, after that, a process of decreasing the power supply voltage is performed by the operation C.

FIG. 8 illustrates a state where the CPU core 111 (CPU 1) as one of the plurality of CPU cores 111 to 11m integrated on the LSI 1 gives an instruction of changing the clock frequency Fs in the system bus 2, and the clock frequency is changed. While the clock frequency Fs of the system bus 2 is changed, the other CPU cores 112 to 11m continue executing the program.

A signal “vdd change start” expresses an instruction of changing the power supply voltage Vdds of the system bus 2 from the CPU core 111 to the DC-DC converter 5, and a signal “vdd change done” expresses that the change of the power supply voltage from the DC-DC converter 5 to the CPU core 111 is completed.

Concretely, via the through circuit 121 (through circuit 1: ST101) and the system bus 2 (ST102), the CPU core 111 write-accesses a power-supply-voltage setting register provided in the DC-DC converter 5 by “vdd change start” (ST103).

In response to the signal, the DC-DC converter 5 changes the power supply voltage Vdds in accordance with the instruction to change the power supply voltage written in the register and sends an instruction (“vdd change done”) expressing completion of the change of the power supply voltage Vdds back to the CPU core 111 (ST104).

For example, a register whose value changes according to whether a change in the power supply voltage is completed or not is provided in the DC-DC converter 5, and the value of the register is polled from the CPU core 111 via the system bus 2. When the value after the change can be read as a result of the polling, the CPU core 111 determines that the change in the power supply voltage has been completed.

A signal “req clock change” expresses that an instruction to change the clock frequency Fs of the system bus 2 is output from the CPU core 111 to the clock generator 4. For example, via the through circuit 121 (ST105) and the system bus 2 (ST106), the clock frequency to be set is written from the CPU core 111 to the clock frequency setting register provided in the clock generator 4 (ST107).

When an instruction is received, the clock generator 4 transmits a signal “clk change start (corresponding to the signal CCS in FIG. 1)” to the control circuit 3 (ST108). The control circuit 3 which receives “clk change start” sets a signal “req snoop” to the snoop circuit 131 to “1” (ST109) and sets a signal “req stop” to the through circuit 121 to “1” (ST110).

The control circuit 3 waits until a signal “snoop done” from the snoop circuit 13 becomes “1” (ST111) and a signal “req snoop” from the through circuit 121 becomes “1” (ST113), and sets a signal “all req stop done” to the clock generator 4 (ST114).

“req snoop” corresponds to “REQ SNOOP1 to REQ SNOOPm” to the snoop circuits 131 to 13m, and “req stop” corresponds to “REQ STOP1 to REQ STOPm” to the through circuits 121 to 12m. Further, “snoop done” corresponds to “SNOOP DONE1 to SNOOP DONEm” from the snoop circuits 131 to 13m.

For example, when the CPU core 111 changes the clock frequency Fs of the system bus 2 (ST115), a match of the clock frequency Fs of the system bus 2 and the clock frequencies F1 to Fm in all of the computation blocks 101 to 10m is checked (ST116).

In other words, a CPU core (computation block) whose clock frequency newly becomes different when the clock frequency Fs of the system bus 2 is changed transmits/receives a signal via a synchronization circuit. Even in a CPU core whose clock frequency is different before the clock frequency Fs of the system bus 2 is changed, when the clock frequency is the same as the clock frequency Fs of the system bus 2 after the change, a synchronization circuit is not interposed.

On the other hand, for example, the case where the CPU core 111 changes a clock frequency F3 (second clock) of the CPU core 113 (first computing process apparatus” will be considered. In this case, the relation between the clock frequencies F1 and F2 and F4 to Fm of CPU cores other than the CPU core 113 (computation block 103) and the clock frequency Fs of the system bus 2 does not change. Therefore, in this case, it is sufficient to check a match between the clock frequency F3 of the CPU core 113 and the clock frequency Fs of the system bus 2.

In the following description, the case where the CPU core 111 changes the clock frequency Fs of the system bus 2 is assumed, and processes in step ST109 and subsequent steps in FIG. 8 will be described by generalizing signals. In other words, description will be given by using the computation blocks 101 to 10m, the CPUi (CPU1 to CPUm: CPU cores 111 to 11m), the through circuits i (121 to 12m), the snoop circuits i (131 to 13m), and the generalized signals.

The snoop circuit i which receives REQ SNOOPi=“1” (i denotes an integer of 1 or larger and m or less) (ST109) checks that an access from CPUi to the system bus 2 is not being executed and, after that, sets “SNOOP DONEi” from the control circuit 3 (ST111) to the through circuit i (ST112) to “1”. The state where the access is not being executed can be determined by checking that the signal REQ2 from the through circuit i is “1”.

The through circuit i which receives REQ STOPi=“1” (ST110) receives SNOOP DONEi=“1” from the snoop circuit i (ST112) and, after that, interrupts a new access from the CPUi to the system bus. After interrupting the new access, a signal “REQ STOP DONEi” to the control circuit 3 is set to “1” (ST113).

In the computation block 101 illustrated in FIG. 3, for example, the control circuit 3 receives SNOOP DONEi=“1” (ST111) and, after that, sets the selection signal SELL to “1”, so that the selector 210 in the through circuit 121 always selects “0” and outputs it regardless of the value of REQ1. The through circuit 121 sets the selection signal SELL to “1” and, after that, sets the signal “REQ STOP DONE1” to the control circuit 3 to “1” (ST113).

Returning to the generalized description again, the control circuit 3 checks that all of signals “REQ STOP DONE1 to m” from the through circuit i became “1” and sets a signal “ALL REQ STOP DONE” to the clock generator 4 to “1” (ST114).

The clock generator 4 which receives “ALL REQ STOP DONE”=“1” (ST114) changes the clock frequency Fs of the system bus 2 (ST115). After completion of the change in the clock frequency Fs, the signal “CLK CHANGE DONE” to the control circuit 3 is set to “1” (ST116).

The control circuit 3 which receives “CLK CHANGE DONE”=“1” (ST116) reads the value of the clock setting register in the clock generator 4 and controls a signal “PATH CHANGE” to the through circuit i (ST117).

In other words, when the clock Fi of the CPUi is the same as the clock Fs of the system bus 2, the control circuit 3 sets the signal CNTi to the through circuit i to “1”. When the clock Fi is different from the clock Fs, the control circuit 3 sets CNTi to “0”.

The selectors 211 to 216 of the through circuit which receive CNTi=“1” select the value on the input “1” side (the value which does not pass through the synchronization circuits 221 to 226) and output the value. On the other hand, the selectors 211 to 216 of the through circuit i which receive CNTi=“0” select the value on the input “0” side (the value synchronized with the circuit on the transmission side via the synchronization circuits 221 to 226) and output the value.

The operation corresponds to the operation A and the description will not be repeated. In other words, steps ST118 to ST121 in the operation C correspond to steps ST101 to ST104 in the operation A.

The above description of FIG. 8 assumes the case that, as a result that the CPU core 111 changes the clock frequency of the system bus 2, the clock frequency of any of the CPU cores 111 to 11m (CPU 1 to m) and the clock frequency of the system bus 2 are different. However, the case where the clock frequency of the CPU and the clock frequency of the system bus become different from each other as a result is also similar.

In other words, for example, the case where the CPU core 111 changes the clock frequency F3 of the CPU core 113 (computation block 103) and, as a result, the clock frequency F3 of the CPU core 113 and the clock frequency Fs of the system bus 2 become different from each other is also similar. In this case, it is sufficient for the control circuit 3 to check, not “SNOOP DONE1 to SNOOP DONEm” from all of the snoop circuits 1 to m but, only “SNOOP DONE3” from the snoop circuit 3 in the computation block 103.

As described above, the snoop circuit i transmits a signal “SNOOP DONEi” notifying of the state where the CPUi is not accessing the system bus and the control circuit 3 receives a signal indicative of no access from all of the snoop circuits i.

The control circuit 3 recognizes no access from all of the snoop circuits i and, after that, transmits a signal “ALL REQ STOP DONE” instructing switching of the clock Fs of the system bus 2 to the clock generator 4.

Therefore, switching of the clock Fs of the system bus 2 can be performed at a timing where there is no access to the system bus 2 from all of the CPUi, so that an erroneous signal can be prevented from being transmitted by execution of an access during changing of the clock.

For example, when the clock frequency Fl of the CPU core 111 and the clock signal Fs of the system bus 2 become the same in FIG. 3, the through circuit 121 connects the CPU core 111 and the system bus 2 via a route not including the synchronization circuits (FFs in two stages) 221 to 226.

In other words, when clocks of different frequencies are supplied to the CPU and the system bus, signals are transmitted/received via a route in which a synchronization circuit is interposed. However, when clocks of the same frequency are supplied, the signals can be transmitted/received directly without passing through a synchronization circuit. When signals are transmitted/received directly without passing through a synchronization circuit as described above, for example, delay of the amount of FFs in two stages in a synchronization circuit can be eliminated.

Further, for example, in FIG. 3, during switching of the clock of the system bus 2, the selector 210 in the through circuit 101 always outputs “0”, thereby enabling an access from the CPU core 111 to the system bus 2 to be interrupted.

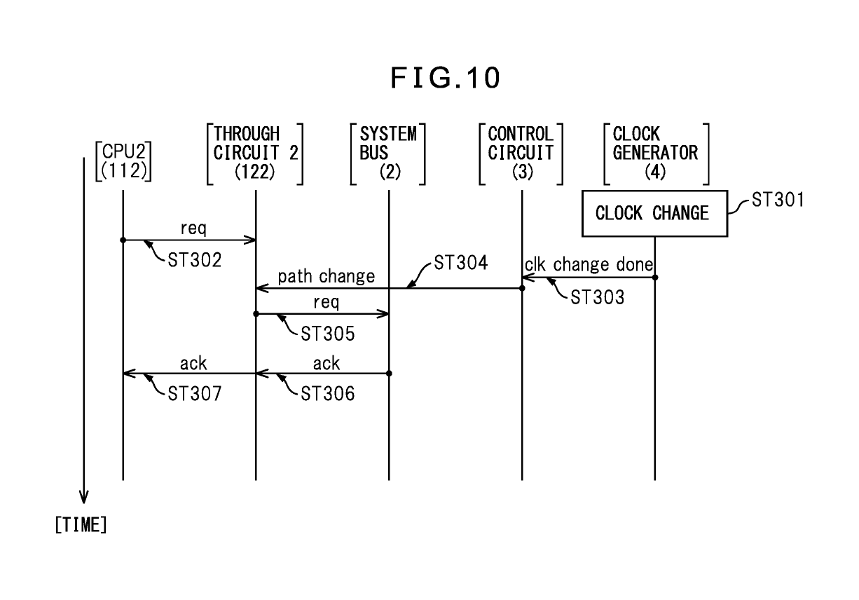

In other words, as will be described in detail later with reference to FIG. 10, even during switching of the clock for the system bus, regardless of whether a program being executed in each CPU accesses the system bus or not, execution of the program can be continued safely.

As described above, according to the embodiment, for example, in the case of changing the clock frequency of the system bus, clock supply is continued to a CPU which does not transmit/receive signals to/from the system bus, and execution of a program on the CPU can be continued. Thus, performance deterioration of the system can be suppressed to the minimum.

It is not limited to the case of changing the clock frequency of a system bus. For example, also when the clock frequency of any one of CPUs is changed and becomes different from the clock frequency of the system bus, performance deterioration of the system can be suppressed. In this case, the operations of the remaining CPUs whose clock frequencies are not changed can be continued.

When the clock frequency of the CPU and that of the system bus are different from each other, signals are transmitted/received via, for example, a synchronization circuit. When the clock frequency of the CPU and that of the system bus are the same, signals can be transmitted/received without passing through the synchronization circuit. Therefore, delay by the synchronization circuit can be avoided.

Obviously, the case where the clock frequency of a CPU and that of a system bus are the same includes, for example, the case where the clock frequency of either a CPU or a system bus is changed and, as a result, the clock frequency of the CPU and that of the system bus became the same.

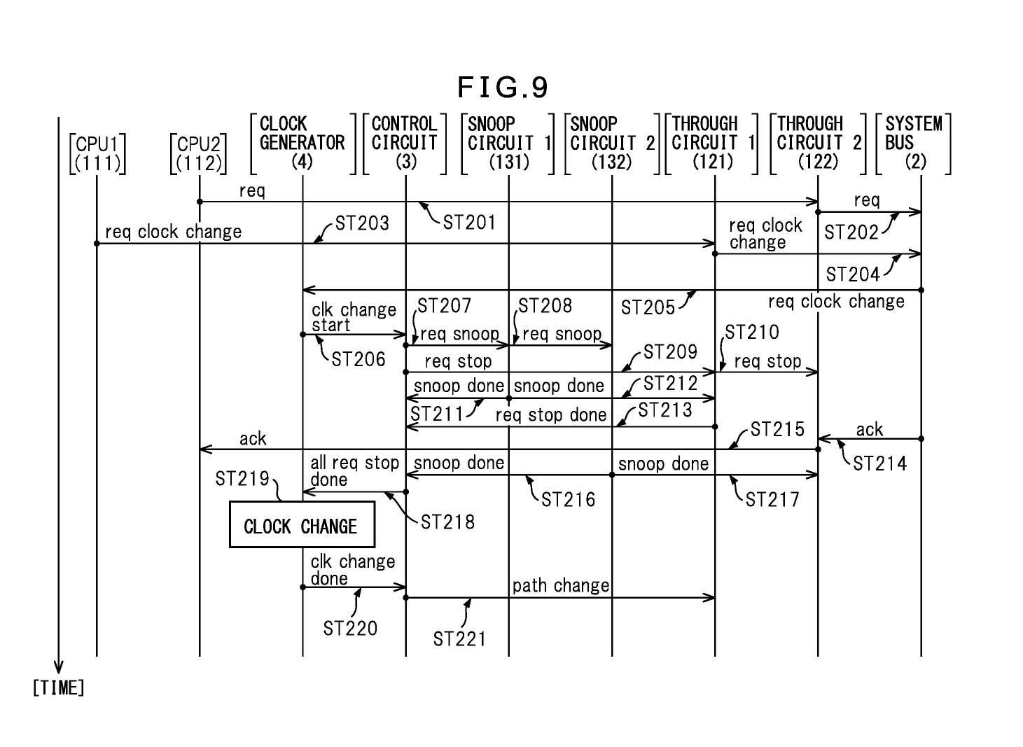

FIG. 9 is a diagram for explaining another example of the operation of changing the clock frequency of a system bus by a CPU, and illustrates operations when the CPU 1 gives an instruction to change the clock frequency of a system bus while the CPU 2 is accessing the system bus.

FIG. 9 illustrates a case of processing the operation B in FIG. 8 in a state where the CPU core 112 (second arithmetic processing unit) outputs a request signal “req” to a peripheral circuit (for example, the peripheral circuit 61) via the through circuit 122 (ST201) and the system bus 2 (ST202) in the operation B in FIG. 8. In this case, an acknowledge signal “ack” from the peripheral circuit 61 is returns to the CPU core 122 (ST215) from the system bus 2 via the through circuit 122 (ST214).

In such a manner, in FIG. 9, the signal “req (REQ1)”=“1” output from the CPU core 112 is transferred to the system bus 2 (ST202) via the through circuit 122 (ST201). Before the acknowledge signal “ack” for the access is output from the system bus 2 (ST214), a signal “req clock change” is output from the CPU 111 (third arithmetic processing unit) (ST203). Further, signals “req snoop (REQ SNOOP1 and REQ SNOOP2)” are output from the control circuit 3 to the snoop circuits 131 and 132 (ST207 and ST208).

The snoop circuit 132 recognizes that the signal “req (REQ1)” from the through circuit 122 changes to “0” and outputs “snoop done (SNOOP DONE2)”=“1” (ST216). The control circuit 3 waits for reception of signals “snoop done (SNOOP DONE1 and SNOOP DONE2)” from all of the snoop circuits (131 and 132) (ST211 and ST216) and outputs “all req stop done”=“1” (ST218).

The other processes in FIG. 9 are substantially the same as those in FIG. 8 except for processes (ST208, ST210, and ST214 to ST217) related to the CPU core 112 (computation block 101) and the description will not be repeated.

In other words, steps ST203 to ST207, ST209, ST211 to ST213, and ST218 to ST221 in FIG. 9 correspond to steps ST105 to ST109, ST110, ST111 to ST113, and ST114 to ST117 in FIG. 8, respectively.

FIG. 10 is a diagram for explaining an example of an operation after the CPU changes the clock frequency of the system bus, and illustrates operations when an access from the CPU core 112 to the system bus 2 is made while the clock frequency Fs of the system bus 2 is being changed.

During change of the clock frequency Fs of the system bus 2 (ST301), the request signal “req” is output from the CPU core 112 to the through circuit 122 (ST302). In other words, REQ1 from the CPU core 112 to the through circuit 122 changes to “1”. While the clock frequency of the system bus 2 is being changed, the selector (access selector) 210 of the through circuit 122 continues outputting “0” to suppress that REQ2 becomes “1”.

When the change of the clock frequency Fs of the system bus 2 completes, a signal “clk change done” is output from the clock generator 4 to the control circuit 3 (ST303). The control circuit 3 confirms that the change of the clock frequency Fs of the system bus 2 is completed and outputs a signal “path change” to the through circuit 122 (ST304).

In other words, when the change of the clock frequency Fs of the system bus 2 is completed, SEL2=″0″ from the control circuit 3 is received. After that, REQ1 from the CPU core 112 is selected and output. Consequently, the request signal “req” is output from the through circuit 122 to the system bus 2 (ST305).

The request signal “req” transferred to the system bus 2 is, for example, output to the peripheral circuit 61 connected to the system bus 2, and the acknowledge signal “ack” from the peripheral circuit is returned from the system bus 2 via the through circuit 122 to the CPU core 112 (ST307).

In such a manner, even during switching of the clock of the system bus, regardless of whether a program being executed in each CPU accesses the system bus or not, execution of the program can be continued safely.

As described above, according to the embodiment, for example, in the case of changing the clock frequency of the system bus, clock supply to a CPU which does not transmit/receive signals to/from the system bus is continued so that execution of a program on the CPU can be continued. Thus, performance deterioration of the system can be suppressed to the minimum.

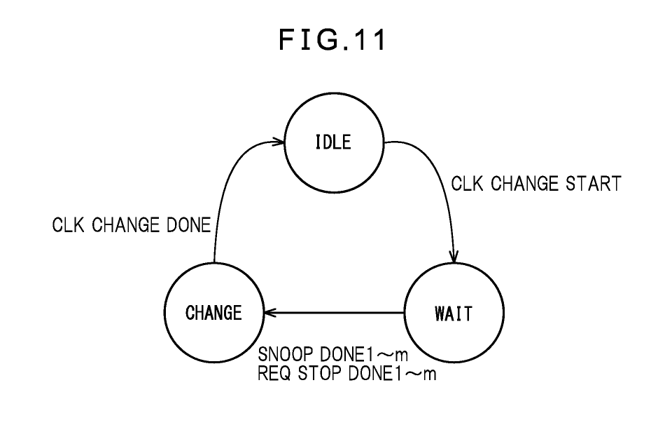

FIG. 11 is a diagram illustrating an example of a state transition machine of a control circuit. As illustrated in FIG. 11, as states of the control circuit 3, three states of an idle state, a wait state, and a change stage exist.

The idle state is a steady state in which the clock of the system bus is not changed and the circuit operates by a predetermined clock signal. When “clk change start”=“1” is received from the clock generator in the idle state, the state shifts to the wait state.

In the wait state, “req snoop (REQ SNOOP1 to REQ SNOOPm)”=“1” and “req stop (REQ STOP1 to REQ STOPm)”=“1” are output. The control circuit 3 waits until all of “SNOOP DONE1 to SNOOP DONEe” and “REQ STOP DONE1 to REQ STOP DONEm” become “1” and shifts to the change state.

As specifically described above, according to the embodiment, in the case of changing the clock frequency of the system bus or any of a plurality of CPUs included in the semiconductor integrated circuit, the CPUs which can operate can continue the process.

Further, for a CPU whose operation frequency becomes different from the clock frequency of the system bus due to the change in the clock frequency, a synchronization circuit is interposed. For a CPU having the same operation frequency, signals are directly transmitted/received. In such a manner, deterioration in the performance due to delay in the synchronization circuit can be suppressed to the minimum.

In the change state, “all req stop done”=“1” is output, and a clock setting value of each of CPUs of the control register in the clock generator and the clock setting value of the system bus are read. Further, when the clocks of the CPUi and the system bus are the same, CNTi=“1” is set and output. When they are different, CNTi=“0” is set and output. The control circuit 3 waits until “clk change done” becomes “1” and shifts to the idle state.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A semiconductor integrated circuit comprising:
a system bus configured to operate at a first clock;
a plurality of arithmetic processing units including a first arithmetic processing unit which is connected to the system bus and operates at a second clock; and
a control circuit configured to control the system bus and the arithmetic processing units, wherein
after checking that an access from the arithmetic processing units to the system bus is not generated, the control circuit changes frequency of the first clock or the second clock.

2. The semiconductor integrated circuit according to claim 1, wherein
each of the arithmetic processing units, a through circuit provided for the arithmetic processing unit, and a snoop circuit provided for the arithmetic processing unit are provided in a computation block, and
a clock signal for each of the arithmetic processing units is given to a circuit included in the computation block in which the arithmetic processing unit is provided.

3. The semiconductor integrated circuit according to claim 2, wherein the through circuit comprises:
a synchronization circuit configured to make a clock frequency of a signal on a transmission side synchronized with a clock frequency of a signal on a reception side in the arithmetic processing unit and the system bus; and
a selector configured to select either the signal on the transmission side or a signal synchronized with the clock frequency of the signal on the reception side by the synchronization circuit.

4. The semiconductor integrated circuit according to claim 3, wherein
when the clock frequency of the arithmetic processing unit and the clock frequency of the system bus are different from each other, the selector selects the signal synchronized with the clock frequency of the signal on the reception side by the synchronization circuit, and
when the clock frequency of the arithmetic processing unit and the clock frequency of the system bus are equal, the selector selects and outputs the signal on the transmission side.

5. The semiconductor integrated circuit according to claim 2, wherein at the time of changing the frequency of the first clock, the control circuit checks that no access is generated from all of the plurality of arithmetic processing units and executes the changing.

6. The semiconductor integrated circuit according to claim 5, wherein the control circuit checks that no access request is generated from all of the arithmetic processing units detected by the snoop circuit and, after that, changes the clock frequency of the system bus.

7. The semiconductor integrated circuit according to claim 2, wherein at the time of changing the frequency of the second clock, the control circuit checks that no access from the first arithmetic processing unit is generated and executes the changing.

8. The semiconductor integrated circuit according to claim 7, wherein after checking that no access request from the first arithmetic processing unit detected by the snoop circuit is generated, the control circuit changes the clock frequency of the first arithmetic processing unit.

9. The semiconductor integrated circuit according to claim 2, wherein each of the through circuits further comprises an access selector configured to interrupt an access request from the arithmetic processing unit during change of the clock frequency without responding to an access request from the arithmetic processing unit.

10. The semiconductor integrated circuit according to claim 1, wherein when a third arithmetic processing unit in the plurality of arithmetic processing units changes the clock frequency of the system bus during execution of an access to the system of a second arithmetic processing unit in the plurality of arithmetic processing units, the control circuit checks completion of the access of the second arithmetic processing unit to the system bus and, after that, changes the clock frequency of the system bus.

11. The semiconductor integrated circuit according to claim 1, wherein power supply voltages and clock frequencies of the plurality of arithmetic processing units and the system bus are independently controlled.

12. A method of controlling a semiconductor integrated circuit including a system bus and a plurality of arithmetic processing units connected to the system bus, the method comprising:
independently controlling power supply voltages and clock frequencies of the plurality of arithmetic processing units and the system bus; and
changing, after checking that no access from the arithmetic processing units to the system bus is generated, the frequency of the first clock or the second clock.

13. The method of controlling a semiconductor integrated circuit according to claim 12, wherein
an arithmetic processing unit which operates at a clock frequency equal to the clock frequency of the system bus outputs signals on a transmission side in the arithmetic processing unit and the system bus as they are as signals on a reception side, and
an arithmetic processing unit which operates at a clock frequency different from the clock frequency of the system bus makes signals on a transmission side in the arithmetic processing unit and the system bus synchronized with a clock frequency of a signal on a reception side and outputs the resultant signal.

14. The method of controlling a semiconductor integrated circuit according to claim 12, wherein an arithmetic processing unit which does not access the system bus in the plurality of arithmetic processing units continues a process which is being executed in the arithmetic processing unit while the clock frequency is being changed.

15. A method of controlling a semiconductor integrated circuit including a system bus and a plurality of arithmetic processing units connected to the system bus, the method comprising:
independently controlling power supply voltages and clock frequencies of the plurality of arithmetic processing units and the system bus; and
at the time of changing the clock frequency of a first arithmetic processing unit in the arithmetic processing units, after checking no generation of an access from the first arithmetic processing unit, the changing is executed.

16. The method of controlling a semiconductor integrated circuit according to claim 15, wherein
an arithmetic processing unit which operates at a clock frequency equal to the clock frequency of the system bus outputs signals on a transmission side in the arithmetic processing unit and the system bus as they are as signals on a reception side, and
an arithmetic processing unit which operates at a clock frequency different from the clock frequency of the system bus makes signals on a transmission side in the arithmetic processing unit and the system bus synchronized with a clock frequency of a signal on a reception side and outputs the resultant signal.

17. The method of controlling a semiconductor integrated circuit according to claim 15, wherein an arithmetic processing unit which does not access the system bus in the plurality of arithmetic processing units continues a process which is being executed in the arithmetic processing unit while the clock frequency is being changed.
